(19) United States
(12) Patent Application Publication
(10) Pub. No.: US 2010/0008073 A1
(43) Pub. Date: Jan. 14, 2010

(54) AIRPORT INSET LIGHTS WITH A FLOW PATH FOR PRESSURE EQUALIZATION

(75) Inventors: Russell Lewis Tartock, Springfield, IL (US); Anthony W. Wilson, Springfield, IL (US); Richard Mula, Westlake Village, CA (US); Albert Boyd Cable, Springfield, IL (US); Todd Hanson, Loretto, MN (US); Aziz Rahman, Springfield, IL (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc.

(21) Appl. No.: 12/169,054

(22) Filed: Jul. 8, 2008

(51) Int. Cl. E01F 9/00; F21S 8/00

(52) U.S. Cl. 362/153.1

(57) ABSTRACT

An airport inset light for an airport runway light system comprises a light fixture incorporating a light source that is covered with a lens. A flow path can be provided in the light fixture such that air can pass unrestrictedly between an exterior environment and an interior space of the light fixture. The flow path can be covered or filled with a hydrophobic filter material, which allows for the light fixture interior to exchange air with its exterior environment. Such a flow path can create pressure equalization between the exterior environment and the light fixture interior to prevent the formation of a vacuum in the light fixture interior. Hence, it can eliminate the possibility of water entering the interior of the light source due to pressure differential between the environment and the light source interior.

### TECHNICAL FIELD

Embodiments are generally related to airport runway light systems and installations. Embodiments are also related to airport inset lights for airport runway/taxiway light systems. Embodiments are also related to inset airport and heliport lights for use in airport runway/taxiway light and heliport touchdown and lift-off (TLOF)/final approach and take-off (FATO) lighting/taxiway systems. Embodiments are additionally related to a pressure equalization system utilized in the context of airport inset lights.

### BACKGROUND OF THE INVENTION

Lighting systems are essential navigational aids for aircrafts, boats, or other vehicles, in providing guidance, signaling and demarcation functions. Modern airports incorporate numerous specialized inset lighting systems for illuminating the edge of an airport runway, taxiway and parking areas to minimize the possibility that an aircraft can inadvertently travel off the edge thereof. The airport inset lighting systems include, but not limited to, runway edge lighting systems, runway touchdown zone lighting systems, runway centerline lighting systems and taxiway centerline lighting systems. The airport inset lights in the runway edges can be specially designed to define runways and taxiways and inhibit pilots from inadvertently driving airplanes off the designated runways and taxiways.

The airport inset lights may be an omni-directional, uni-directional, or bi-directional light fixture including a light cover and a light base housing that is embedded into the ground. The light fixture is attached to an installation bucket with the help of threaded bolts. The light cover is attached to a light base housing in order to cover the set of components of the airport inset lights. The light fixture can incorporate a light source assembled with a lens. The light source can be electrically connected to an electrical lead via the light base housing in order to connect the light source to the electrical wiring of the airport runway light systems.

Moreover, these airport inset lights are required to be tested to twenty pounds per square inch (psi) of internal pressure without leaking prior to shipment. Then, the sealed product of the airport inset lights can be subjected to flexural and thermal stresses, which creates a pressure difference between the external environment and the interior of the light fixture. The majority of prior art airport inset lights can suffer from the pressure differential problem, which results in water being drawn into the interior of the light fixture, potentially damaging the light source. Therefore, it is desirable to provide means for pressure equalization between the external environment and the light fixture interior of the airport inset light.

In an effort to address the foregoing difficulties, it is believed that a need exists for an improved airport inset light that eliminates the possibility of water entering the interior of the light fixture. It is believed that the improved airport inset light disclosed herein can address these and other continuing needs.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an improved airport inset light for airport runway light systems.

It is another aspect of the present invention to provide for a flow path for pressure equalization, utilized in the context of airport inset lights.

The aforementioned aspects and other objectives and advantages can now be achieved as described herein. An improved airport inset light for an airport runway light system comprises a light fixture incorporating a light source that is covered with a lens. A flow path can be provided in the light fixture such that air can pass unrestrictedly between an exterior environment and an interior space of the light fixture. The flow path can be covered or filled with a hydrophobic filter material, which allows for the light fixture interior to exchange air with its exterior environment. Such a flow path can create pressure equalization between the exterior environment and the light fixture interior to prevent forming a vacuum in the light fixture interior. Hence, it can eliminate the possibility of water entering the interior of the light fixture due to pressure differential between the environment and the light fixture interior.

Furthermore, the light cover can be attached to a light base housing in order to cover the light source of the airport inset light. The light fixture can be embedded into the ground with the help of threaded bolts. The hydrophobic filter material can be composed of a composite material, such as, for example, Gortex™, Teflon™, or nylon. The flow path can permit venting of air from the exterior environment to the light fixture interior and vice-versa, for pressure equalization. Such a flow path can prevent water intrusion into the light fixture even when the airport inset light can be subjected to flexural and thermal stresses.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a schematic view of an airport inset light for an airport runway light system, in accordance with a preferred embodiment;

FIG. 2 illustrates a schematic cross-sectional view of the airport inset light as shown in FIG. 1, in accordance with a preferred embodiment;

FIG. 3 illustrates a top plan view of an airport runway light system incorporating airport inset lights constructed and arranged in accordance with a preferred embodiment; and

FIG. 4 illustrates a top plan view of a heliport landing area lighting system incorporating airport inset lights constructed and arranged in accordance with an alternative embodiment.

### DETAILED DESCRIPTION

The particular values and configurations discussed in these non-limiting examples can be varied and are cited merely to illustrate at least one embodiment and are not intended to limit the scope thereof.

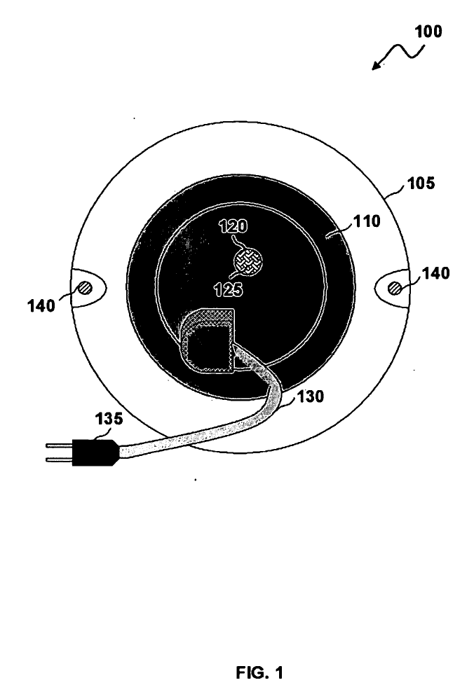

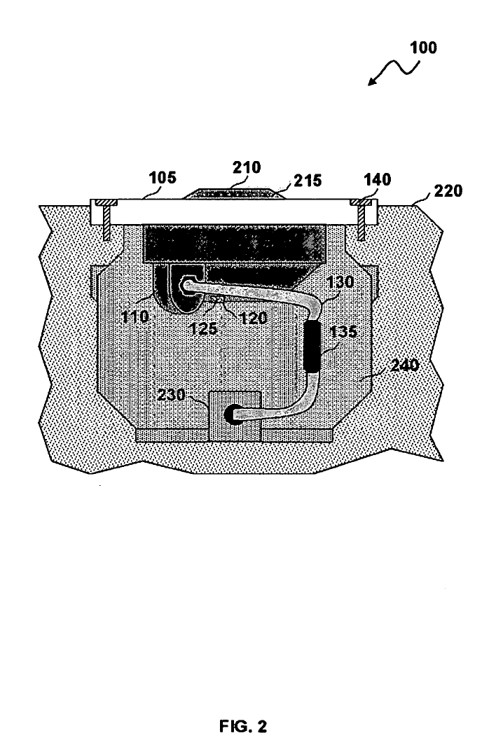

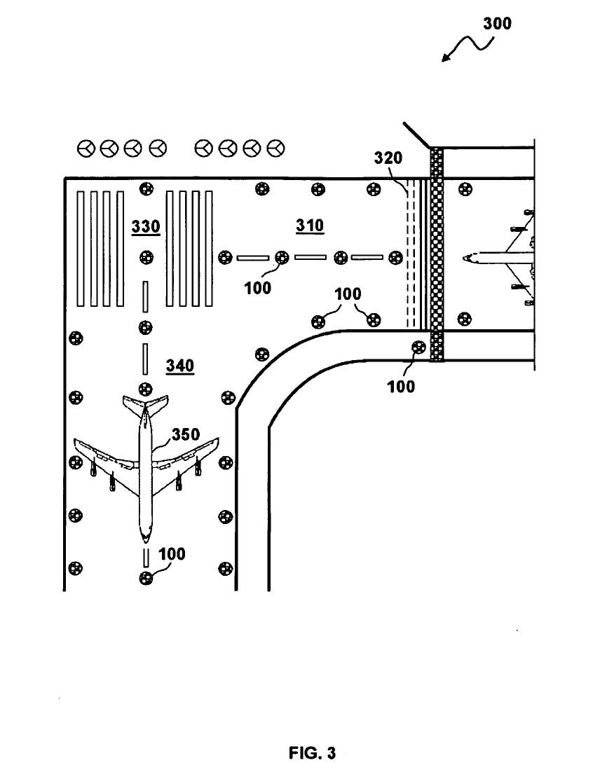

FIG. 1 illustrates a schematic view of an airport inset light 100 for an airport runway light system 300, in accordance with a preferred embodiment. The airport inset light fixture 100 comprises a light cover 105 that can be mounted to a light base housing 110 in order to cover a light source 210, as illustrated in FIG. 2, of the airport inset light fixture 100. The light fixture 100 can be embedded into the ground 220, as illustrated in FIG. 2, with the help of threaded bolts 140. Note that the embodiments discussed herein generally relate to airport runway light systems 300, as illustrated in FIG. 3. It can be appreciated, however, that such embodiments can be implemented in the context of other lighting systems and designs and are not limited to the airport runway light system 300. The discussion of airport runway light systems 300, as utilized herein, is presented for general illustrative purposes only.

Moreover, the airport inset light 100 can include at least one flow path 120 that is provided in the light fixture 100. However, multiple flow paths 120 can also be provided in the light fixture 100 without departing from the scope of the invention. The flow path 120 can be designed in a hollow circular manner, depending upon design considerations. It can be appreciated, of course, that other shapes may be utilized to implement the flow path 120. The flow path 120 can allow air to be unrestrictedly passed between an exterior environment and an interior space of the light fixture 100. The flow path 120 may be implemented in either the light cover 105 or the light base housing 110. The light source 210 can be electrically connected to an electrical lead 130, through which a source of power can be provided to the light source 210. The electrical lead 130 can be attached to one or more electrical connectors 135, which are in contact with a main power supply 230, as illustrated in FIG. 2, of the airport runway light system 300.

In addition, the flow path 120 can be covered/filled with a hydrophobic filter material 125, which allows for the interior of the light fixture 100 to exchange air with its exterior environment while preventing the exchange of water and water vapor. Such a flow path 120 can create pressure equalization between the exterior environment and the light fixture interior to prevent forming a vacuum in the interior of the light fixture 100. Hence, the flow path 120 with the filter material 125 can eliminate the possibility of water entering the interior of the light source 210 due to pressure differential between the environment and the interior of the light fixture 100.

FIG. 2 illustrates a schematic cross-sectional view of the airport inset light 100, as shown in FIG. 1, in accordance with a preferred embodiment. Note that in FIGS. 1-3, identical parts or elements are generally indicated by identical reference numerals. The light cover 105 incorporates the light source 210 that is covered with a lens 215. The light cover 105 and the light base housing 110 can be made from a one-piece aluminum casting, depending upon design considerations. The light source 210 can be electrically connected to the electrical lead 130 via the light base housing 110. The airport inset light fixture 100 can be secured to an installation bucket 240.

Furthermore, the flow path 120 can permit venting of air from the exterior environment to the light fixture 100 interior for pressure equalization while water is substantially prevented from passing through the flow path 120. Such a flow path 120, when covered/filled with a hydrophobic filter material 125, can prevent water entering into the light fixture 100 even when the airport inset light fixture 100 is subjected to flexural and thermal stresses. The hydrophobic filter material 125 located in the flow path 120 can be composed of material such as, for example, Gortex™, Teflon™ and/or nylon, depending upon design considerations. It can be appreciated, of course, that other materials may be utilized to implement the hydrophobic filter material 125. The flow path 120 with the hydrophobic filter material 125 can be employed in, but not limited to, omni-directional, uni-directional, and/or bi-directional airport inset lights 100. It should here be noted that these airport inset lights 100 can withstand stresses imposed by rollover and static loads of airplanes 350, as illustrated in FIG. 3, without damage to the inset lights 100 and/or airplane tires.

FIG. 3 illustrates a top plan view of an airport runway light system 300 incorporating airport inset lights 100 constructed and arranged in accordance with a preferred embodiment. Note that in FIGS. 1-3, identical parts or elements are generally indicated by identical reference numerals. The airport inset lights 100 can be installed on a side of a runway/taxiway 310 and/or near to a hold line 320 for a runway entrance control at a controlled or uncontrolled airfield. These airport inset lights 100 can provide a clear illumination to the runway/taxiway 310, or an intersection 330 of runway 310 with another runway/taxiway 340. The airport inset lights 100 can also guide pilots to drive airplanes 350 in the runways/taxiways 310 and 340 after reaching a runway holding position identified by the hold line 320. The airport inset light fixtures 100 can also be installed on a centerline of the runways/taxiways 310 and 340. The airport inset lights 100 can be secured to the ground 220 or to the installation bucket 240, and electrically coupled to the electrical main line 230, as illustrated in FIG. 2, of the airport runway light system 300.

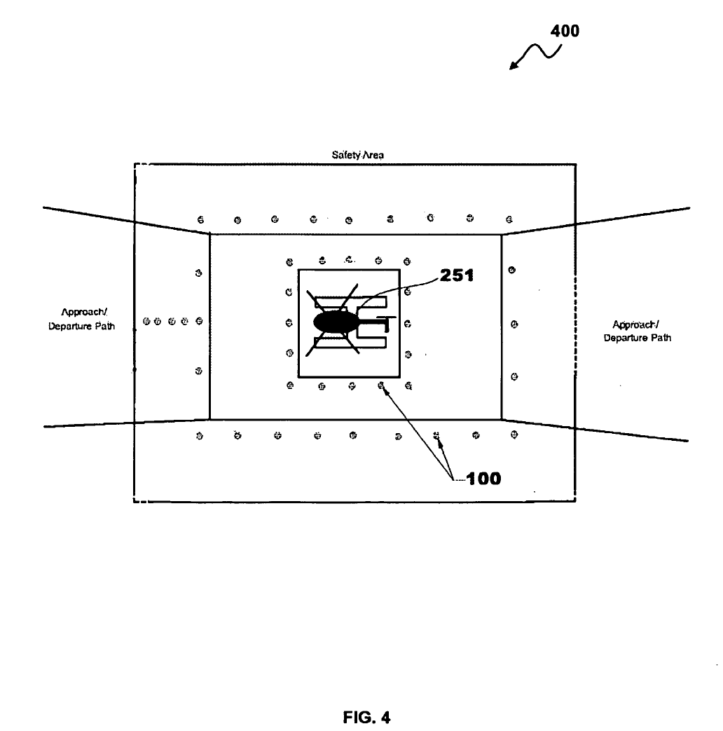

FIG. 4 illustrates a top plan view of a heliport landing area lighting system 400 incorporating airport inset lights 100 constructed and arranged in accordance with an alternative embodiment. Note that in FIGS. 1-4, identical or similar parts or elements are generally indicated by identical reference numerals. In the configuration depicted in FIG. 4, rather than airport runways 310 and 340 and airplane 350 as indicated in FIGS. 1-3, the present invention can be embodied in the context of a heliport landing area lighting system 400 for guiding a helicopter 251 along an appropriate approach/departure path and appropriate landing point. A number of inset airport lights 100 can be implemented within the context of the design depicted in FIG. 4. The inset airport/heliport light apparatus 100 can thus be implemented in association with a number of runway light and heliport touchdown and lift-off (TLOF)/final approach and take-off (FATO) lighting systems.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. An airport inset light apparatus, comprising:
a light fixture incorporating a light cover and at least one light source for generating light, wherein said at least one light source is covered with at least one lens;
at least one flow path provided in said light fixture such that air passes unrestrictedly between an exterior environment and an interior of said light fixture, wherein said at least one flow path is associated with said at least one light source; and
at least one hydrophobic filter material adapted for covering said at least one flow path in order to exchange air from said light fixture interior with said exterior environment, wherein said at least one flow path creates pressure equalization between said exterior environment and said interior of said light fixture, thereby eliminating the possibility of water entering said interior of said light fixture.

2. The apparatus of claim 1 wherein said at least one flow path prevents the formation of a vacuum in said interior of said light fixture.

3. The apparatus of claim 1 wherein said at least one hydrophobic filter material comprises a composite material

4. The apparatus of claim 1 wherein said light cover is mounted to a light base housing to cover said at least one light source.

5. The apparatus of claim 1 wherein said light fixture is embedded into a surface of a ground by utilizing a plurality of threaded bolts.

6. The apparatus of claim 1 wherein said airport inset light is installed on a side of a runway.

7. The apparatus of claim 1 wherein said airport inset light is installed on a runway centerline.

8. The apparatus of claim 1 wherein said airport inset light is installed on a taxiway centerline.

9. An airport inset light apparatus, comprising:
a light fixture incorporating a light cover and at least one light source for generating light, wherein said at least one light source is covered with at least one lens;
at least one flow path provided in said light fixture such that air passes unrestrictedly between an exterior environment and an interior of said light fixture, wherein said at least one flow path is associated with said at least one light source;
a light base housing, wherein said light cover is mounted to said light base housing to cover said at least one light source; and
at least one hydrophobic filter material adapted for filling said at least one flow path in order to exchange air from said light fixture interior with said exterior environment, wherein said at least one flow path creates pressure equalization between said exterior environment and said interior of said light fixture, thereby eliminating the possibility of water entering said interior of said light fixture.

10. The apparatus of claim 9 wherein said at least one flow path prevents the formation of a vacuum in said interior of said light fixture.

11. The apparatus of claim 9 wherein said at least one hydrophobic filter material comprises a composite material.

12. A method for configuring an airport inset light apparatus, comprising:
providing a light fixture incorporating a light cover and at least one light source for generating light;
covering said at least one light source with at least one lens;
configuring at least one flow path in said light fixture such that air passes unrestrictedly between an exterior environment and an interior of said light fixture;
associating said at least one flow path with said at least one light source; and
adapting at least one hydrophobic filter material for covering said at least one flow path in order to exchange air from said light fixture interior with said exterior environment, wherein said at least one flow path creates pressure equalization between said exterior environment and said interior of said light fixture, thereby eliminating the possibility of water entering said interior of said light fixture.

13. The method of claim 12 further comprising configuring said at least one flow path to prevent the formation of a vacuum in said interior of said light fixture.

14. The method of claim 12 further comprising configuring said at least one hydrophobic filter material from a composite material

15. The method of claim 12 further comprising mounting said light cover mounted to a light base housing to cover said at least one light source.

16. The method of claim 12 further comprising embedding said light fixture embedded into a surface of a ground utilizing a plurality of threaded bolts.

17. The method of claim 12 further comprising:
configuring said at least one flow path to prevent the formation of a vacuum in said interior of said light fixture;
configuring said at least one hydrophobic filter material from a composite material; and
mounting said light cover mounted to a light base housing to cover said at least one light source.

18. The method of claim 12 further comprising installing said airport inset light on a side of a runway.

19. The method of claim 12 further comprising installing said airport inset light on a runway centerline.

20. The method of claim 12 further comprising installing said airport inset light on a taxiway centerline.
